(19) United States
(12) Patent Application Publication
(10) Pub. No.: US 2007/0022235 A1
(43) Pub. Date: Jan. 25, 2007

(54) Non-volatile storage device with thin display unit

(76) Inventors: Li-Pai Chen, Sindian City (TW); Ming-Dar Chen, Sindian City (TW); Hsiang-An Hsieh, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/260,399

(22) Filed: Oct. 28, 2005

(30) Foreign Application Priority Data
Jul. 22, 2005 (TW) 94212441

(51) Int. Cl. G06F 13/38

(52) U.S. Cl. 710/62

(57) ABSTRACT

A non-volatile storage device with a thin display unit is described. The non-volatile storage device has a thin display unit, a non-volatile storage unit, a connection interface, and a package unit. Therein, the non-volatile storage unit further has a controller and a non-volatile storage medium. The thin display unit further has a transmission interface. The package unit further has a display window. The controller sends status information of the non-volatile storage medium to the thin display unit via the connection between the connection interface and the transmission interface. Then, a user can view the status information shown on the display unit via the display window directly.

### BACKGROUND OF THE INVENTION

1. Field of the Invention

The present invention is related to a non-volatile storage device with a display unit, and more particularly to a non-volatile storage device that has a thin display unit.

2. Description of Related Art

Conventional non-volatile storage devices, such as compact flash (CF) memory cards, multimedia cards (MMC), secure digital (SD) memory cards, memory stick (MS) cards, and thumb drives with USB interfaces, generally don't have display units. Apart from the labels attached to the storage devices that show the storage capacities, the storage devices cannot show their current status when in use.

Although some portable devices, for example, MP3 players and backup memory cards, have display units that can show their remaining memory capacity, they need to have built-in power supplies. Moreover, the display units used by these portable devices are too large in size. Due to these two problems, the memory cards with compact sizes cannot be equipped with display units. For conventional USB thumb drives, although some of them have been equipped with display units, their sizes cannot be further reduced because of the large-scale display unit.

Taiwan Utility Patent No. M253035 discloses a storage device with a display unit that displays its memory capacity. Although the technique described in this patent shows information regarding the device's storage capacity, it cannot be applied to devices that are compact in size.

Accordingly, as discussed above, the prior art still has some drawbacks that can be improved upon. The present invention aims to resolve the drawbacks of the prior art.

### SUMMARY OF THE INVENTION

An objective of the present invention is to provide a non-volatile storage device with a thin display unit. The present invention uses a display unit that has a smaller size together with a connection interface for reducing the overall size. Hence, the present invention can be applied to devices with compact sizes to equip them with display units to show their current status.

For achieving the object above, the present invention provides a non-volatile storage device with a thin display unit. Therein, the present invention has a non-volatile storage unit connected to an external application system for storing digital information. Furthermore, the present invention has a controller that is used to read and analyze specific information recorded on a non-volatile storage medium of the non-volatile storage device and sends status information to a bistable thin display unit via the electrical connection between a connection interface and a transmission interface. Furthermore, the present invention has a package unit that has a transparent portion for displaying the status information shown on the display unit.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a block diagram of the present invention;

FIG. 2 is a cross-sectional view of the first embodiment in accordance with the present invention;

FIG. 3 is a cross-sectional view of the second embodiment in accordance with the present invention;

FIG. 4 is a cross-sectional view of the third embodiment in accordance with the present invention

FIG. 5 shows the installation of the thin display unit into the package unit; and

FIG. 6 shows an application of the present invention for the SD memory card.

### DETAILED DESCRIPTION OF PREFERRED EMBODIMENTS

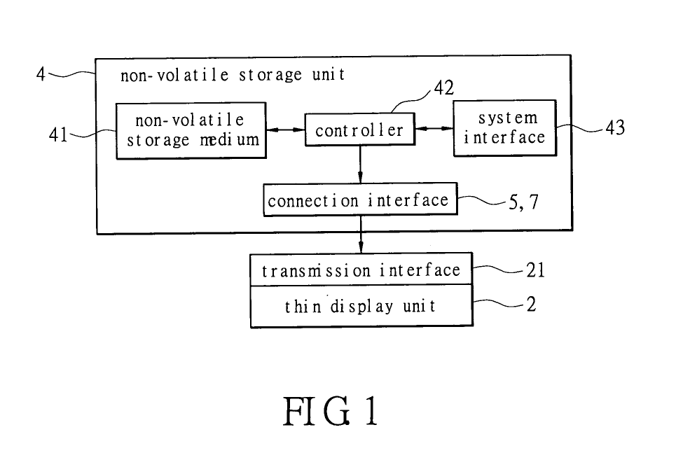

Reference is made to FIG. 1, which is a block diagram of the present invention. In the figure, the non-volatile storage unit 4 includes a controller 42. The controller 42 is connected to an external application system via a system interface 43. The controller 42 is also used to read and analyze information recorded in the non-volatile storage medium 41 and sends status information to a transmission interface 21 via a connection interface 5 to show the status information on the thin display unit 2.

The thin display unit 2 of the present invention is characterized by its use of a substrate with a small thickness. The substrate has an optoelectronic material whose stable status is changed due to the affection of electric fields, electric currents or other electromagnetic effects. After the optoelectronic material is arranged appropriately on the substrate, the status information can be shown thereon by changing its stable status.

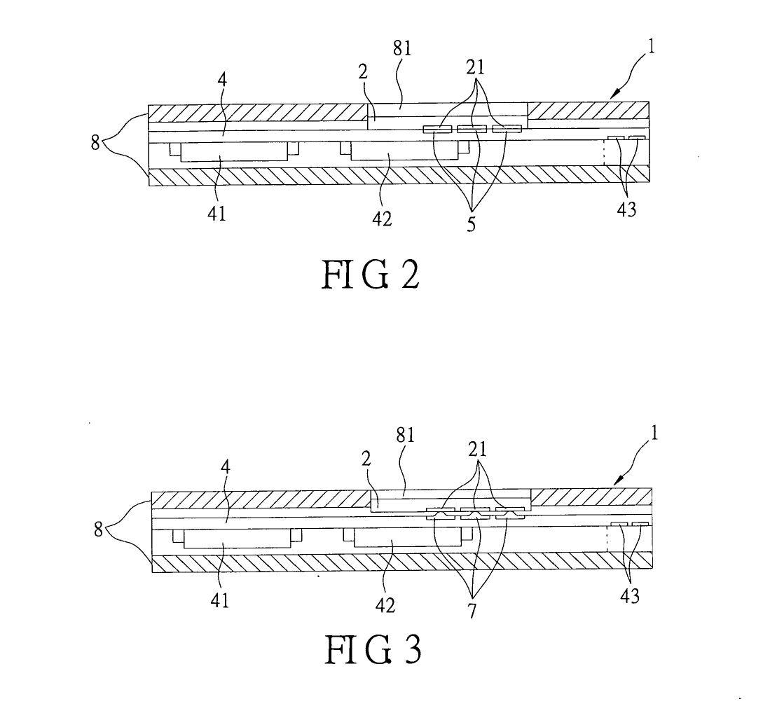

The structure of the first embodiment of present invention is shown in FIG. 2, which is a cross-sectional view of the first embodiment in accordance with the present invention. Therein, the thin display unit 2 is a bistable one. Except for having a small size, the thin display unit 2 can constantly show the status of the non-volatile storage device 1 without connecting to the application system or having a built-in power supply.

The thin display unit 2 is installed in the package unit 8. The package unit 81 forms a periphery of the non-volatile storage device 1 and has a display window formed corresponding to the location of the thin display unit 2. Furthermore, the package unit 81 can be made of a transparent material for displaying the information shown on the thin display unit 2. Therein, the thin display unit 2 further has a transmission interface 21, which includes conductive contacts made of metal. The conductive contacts can further have projective portions for easily contacting with other contacts when packaged. The projective portions can be ball-shaped or spike-shaped.

Furthermore, the non-volatile storage unit 4 includes at least one non-volatile storage medium 41, a controller 42, a system interface 43 and a connection interface 5. Therein, the connection interface 5 includes conductive contacts made of metal and is disposed at a location corresponding to the transmission interface 21. The package unit 8 presses the transmission interface 21 to electrically contact the connection interface 5. Thereby, the controller 42 can transmit the status information of the non-volatile storage medium 41 to the thin display unit 2 for display. In other words, the controller 42 connects to the transmission interface 21 via the connection interface 5 to control the thin display unit 2 to show the status information. Furthermore, the controller 42 also connects to an external application system via the system interface 43 to store digital information.

Moreover, the installation of the above-mentioned thin display unit 2 into the package unit 8 can be performed as show in FIG. 5. When the thin display unit 2 is installed in the non-volatile storage unite 4, pressing the package unit 8 makes the transmission interface 21 electrically and closely connect with the connection interface 5. The transmission interface 21 can also be welded directly onto the connection interface 5 so that the thin display unit 2 can connect electrically to the non-volatile storage unit 4. Then, the package unit 8 can be applied for packaging.

The package unit 8 can include an upper cover and a lower cover or be composed of multiple components. The package unit 8 can also be a single shell with a package material used to glue the components when they are placed in the shell. The package unit 8 can also be formed integrally via a mold after all of the components are combined.

Reference is made to FIG. 3, which is a cross-sectional view of the second embodiment in accordance with the present invention. Therein, the thin display unit 2 is a bistable one. Apart from having a small size, the thin display unit 2 can constantly show the status of the non-volatile storage device 1 without connecting to the application system or having a built-in power supply.

The thin display unit 2 is installed in the package unit 8. The package unit 81 forms a periphery of the non-volatile storage device 1 and has a display window formed corresponding to the location of thin display unit 2. Furthermore, the package unit 81 can be made of a transparent material for displaying the information shown on the thin display unit 2. Therein, the thin display unit 2 further has a transmission interface 21, which includes conductive contacts made of metal.

On the other hand, the non-volatile storage unit 4 includes a non-volatile storage unit 41, a controller 42, a system interface 43 and a connection interface 7 with conductive projections. Therein, the conductive projections of the connection interface 7 can be ball-shaped or spike-shaped. The connection interface 7 is disposed at a location corresponding to the transmission interface 21. Pressing the package unit 8 makes the transmission interface 21 electrically contact the connection interface 7. Due to the conductive projections, the connection interface 7 can easily contact electrically with other contacts. Thus, via the electrical connection between the connection interface 7 and the transmission interface 21, the controller 42 can transmit the status information of the non-volatile storage medium 41 to the thin display unit 2 for display. In other words, the controller 42 connects to the transmission interface 21 via the connection interface 7 to control the thin display unit 2 to show the status information. Furthermore, the controller 42 also connects to an external application system via the system interface 43 to store digital information.

Moreover, the installation of the above-mentioned thin display unit 2 into the package unit 8 can be performed as show in FIG. 5. When the thin display unit 2 is installed in the non-volatile storage unit 4, pressing the package unit 8 makes the transmission interface 21 electrically and closely with the connection interface 7.

The package unit 8 can include an upper cover and a lower cover or be composed of multiple components. The package unit 8 can also be a single shell with a package material used to glue the components when they are placed in the shell. The package unit 8 can also be formed integrally via a mold after all of the components are combined.

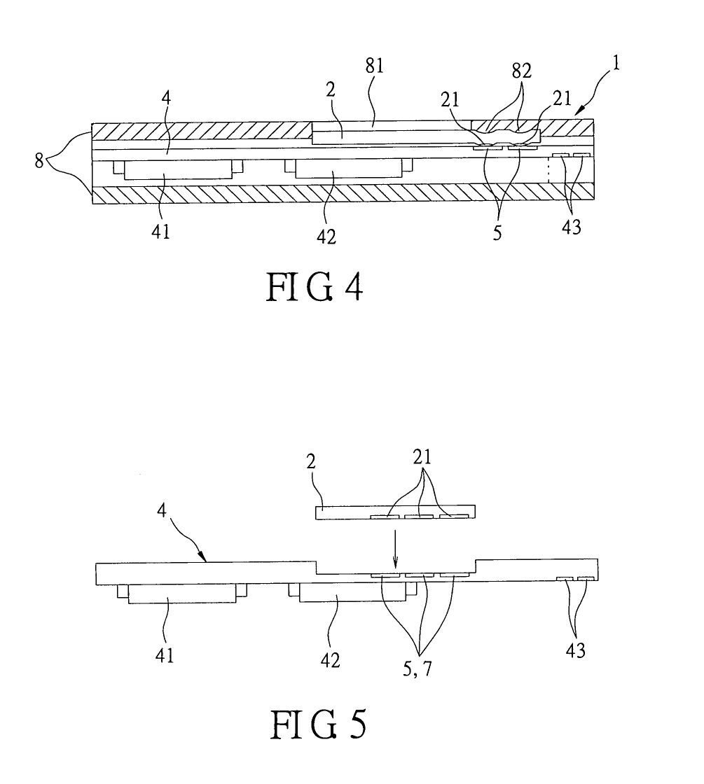

The structure of the third embodiment of the present invention is shown in FIG. 4, which is a cross-sectional view of the third embodiment in accordance with the present invention. Therein, the thin display unit 2 is a bistable one. Apart from having a small size, the thin display unit 2 can constantly show the status of the non-volatile storage device 1 without connecting to the application system or having a built-in power supply.

The thin display unit 2 is installed in the package unit 8. The package unit 81 forms a periphery of the non-volatile storage device 1 and has a display window formed corresponding to the location of the thin display unit 2. Furthermore, the package unit 81 can be made of a transparent material for displaying the information shown on the thin display unit 2. Therein, the thin display unit 2 further has a transmission interface 21, which includes conductive contacts made of metal.

Furthermore, the non-volatile storage unit 4 includes at least one non-volatile storage medium 41, a controller 42, a system interface 43 and a connection interface 5. Therein, the connection interface 5 includes conductive contacts made of metal and disposed at a location corresponding to the transmission interface 21. The package unit 8 has one or multiple projective portions 82 located corresponding to the transmission interface 21. Due to the projective portions 82, the package unit 8 presses the flexible thin display unit 2 to make the transmission interface 21 electrically and closely contact with the connection interface 5. Thereby, via the electrical connection between the connection interface 5 and the transmission interface 21, the controller 42 can transmit the status information of the non-volatile storage medium 41 to the thin display unit 2 for display. In other words, the controller 42 connects to the transmission interface 21 via the connection interface 5 to control the thin display unit 2 to show the status information. Furthermore, the controller 42 also connects to an external application system via the system interface 43 to store digital information.

Moreover, the installation of the above-mentioned thin display unit 2 into the package unit 8 can be performed as shown in FIG. 5. When the thin display unit 2 is installed in the non-volatile storage unit 4, pressing the package unit 8 makes the transmission interface 21 electrically and closely connect with the connection interface 5. The transmission interface 21 can also be welded directly onto the connection interface 5 so that the thin display unit 2 can electrically connect to the non-volatile storage unit 4. Next, the package unit 8 is applied for packaging.

The package unit 8 includes an upper cover and a lower cover or is composed of multiple components. The package unit 8 can also have a single shell with a package material used to glue the components when they are placed in the shell. The package unit 8 can also be formed integrally via a mold after all of the components are combined.

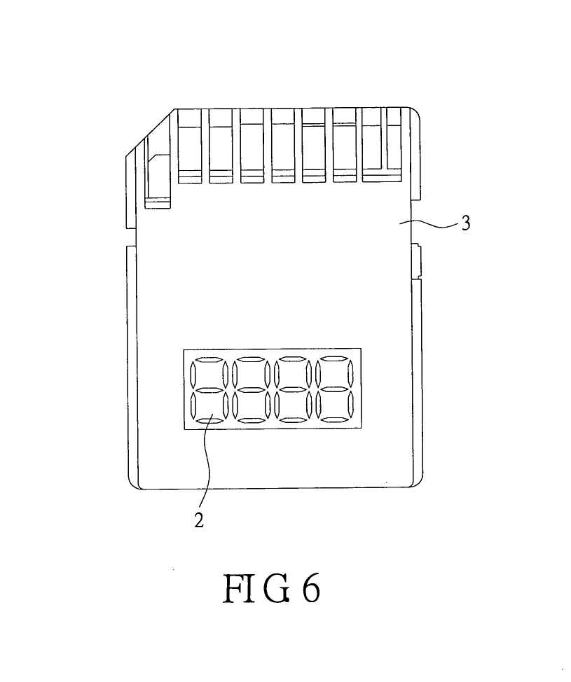

To sum up, the present invention can be applied for various non-volatile storage devices that are small in size, such as compact flash (CF) memory cards, multimedia cards (MMC), secure digital (SD) memory cards, and memory stick (MS) cards. FIG. 6 shows an application of the present invention for the SD memory card. As shown in FIG. 6, status information can be shown on the SD memory card 3. Thus, the problem of the prior art that display units cannot be disposed on some storage devices because of their small sizes is overcome. Furthermore, by using the present invention, the size of conventional USB thumb drives with display units can be further reduced.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are embraced within the scope of the invention as defined in the appended claims.

What is claimed is:

1. A non-volatile storage device, comprising:
a thin display unit used to display status information of the non-volatile storage device;
a non-volatile storage unit used to store digital information and make the status information shown on the display unit;
a connection interface disposed on the non-volatile storage unit and electrically connecting to the thin display unit for transmitting signals between the non-volatile storage unit and the thin display unit;
a package unit forming a periphery of the non-volatile storage device and having a display window for displaying the status information.

2. The non-volatile storage device as claimed in claim 1, wherein the thin display unit is a bistable one.

3. The non-volatile storage device as claimed in claim 1, wherein the thin display unit includes a transmission interface that electrically connects to the connection interface.

4. The non-volatile storage device as claimed in claim 3, wherein the transmission interface has one or multiple conductive projections.

5. The non-volatile storage device as claimed in claim 3, wherein the package unit has one or multiple projective portions located corresponding to the transmission interface, and the package unit presses the thin display unit to make the transmission interface electrically and closely contact the connection interface via the projective portions.

6. The non-volatile storage device as claimed in claim 1, wherein the non-volatile storage unit further includes a controller and at least one non-volatile storage medium, and the controller reads and analyzes specific information recorded in the non-volatile storage medium and then sends the status information to the thin display unit via the connection interface.

7. The non-volatile storage device as claimed in claim 1, wherein the thin display unit is installed in the package unit, and pressing the package unit makes a transmission interface of the thin display unit closely and electrically contact the connection interface.

8. The non-volatile storage device as claimed in claim 1, wherein the thin display unit is installed on the non-volatile storage unit, and pressing the package unit makes a transmission interface of the thin display unit closely and electrically contact the connection interface.

9. The non-volatile storage device as claimed in claim 1, wherein the display unit has a transmission interface that is welded onto the connection interface of the non-volatile storage unit.

10. The non-volatile storage device as claimed in claim 1, wherein the package unit has an upper cover and a lower cover.

11. The non-volatile storage device as claimed in claim 1, wherein the package unit is a single shell with a package material used to glue the components of the non-volatile storage device onto the shell.

12. The non-volatile storage device as claimed in claim 1, wherein the package unit is formed integrally via a mold after the components of the non-volatile storage are combined.

13. The non-volatile storage device as claimed in claim 1, wherein the package unit is composed of multiple components.

14. The non-volatile storage device as claimed in claim 1, wherein the package unit is made of a transparent material.

15. A non-volatile storage device, comprising:
a thin display unit used to display status information of the non-volatile storage device;
a non-volatile storage unit used to store digital information and show the status information on the display unit;
a connection interface having conductive projections, being disposed on the non-volatile storage unit, and electrically connecting to the thin display unit for transmitting signals between the non-volatile storage unit and the thin display unit;
a package unit forming a periphery of the non-volatile storage device and having a display window for displaying the status information.

16. The non-volatile storage device as claimed in claim 15, wherein the thin display unit includes a transmission interface that electrically connects to the connection interface.

17. The non-volatile storage device as claimed in claim 15, wherein the thin display unit is a bistable one.

18. The non-volatile storage device as claimed in claim 15, wherein the non-volatile storage unit further includes a controller and at least a non-volatile storage medium, and the controller reads and analyzes specific information recorded in the non-volatile storage medium and then sends the status information to the thin display unit via the connection interface.

19. The non-volatile storage device as claimed in claim 15, wherein the thin display unit is installed in the package unit, and pressing the package unit makes a transmission interface of the thin display unit closely and electrically contact the connection interface.

20. The non-volatile storage device as claimed in claim 15, wherein the thin display unit is installed on the non-volatile store unit, and pressing the package unit makes a transmission interface of the thin display unit closely and electrically contact the connection interface.

21. The non-volatile storage device as claimed in claim 15, wherein the package unit has an upper cover and a lower cover.

22. The non-volatile storage device as claimed in claim 15, wherein the package unit is a single shell with a package material used to glue the components of the non-volatile storage device onto the shell.

23. The non-volatile storage device as claimed in claim 15, wherein the package unit is formed integrally via a mold after the components of the non-volatile storage are combined.

24. The non-volatile storage device as claimed in claim 15, wherein the package unit is composed of multiple components.

25. The non-volatile storage device as claimed in claim 15, wherein the package unit is made of a transparent material.
